(19) United States
(12) Patent Application Publication
(10) Pub. No.: US 2017/0300138 A1
(43) Pub. Date: Oct. 19, 2017

(54) INFORMATION INPUT PEN

(71) Applicant: Sharp Kabushiki Kaisha, Osaka (JP)

(72) Inventors: YAN QIAN, Osaka (JP); TAMIYO NAKABAYASHI, Osaka (JP)

(73) Assignee: Sharp Kabushiki Kaisha, Osaka (JP)

(21) Appl. No.: 15/515,967

(22) PCT Filed: Aug. 31, 2015
(86) PCT No.: PCT/JP2015/074738

§ 371 Date: Mar. 30, 2017

(30) Foreign Application Priority Data
Oct. 3, 2014 (JP) 2014-205263

(51) Int. Cl. G06F 3/0354; G06F 3/044; G06F 3/041

(52) U.S. Cl. CPC G06F 3/03545; G06F 3/0418; G06F 3/044

(57) ABSTRACT

A conductive section (13) is disposed at an inclination of 30 degrees with respect to a pen body (10). When a pen tip (12) comes into contact with or proximity to a touch surface of a touch panel (2), an angle of inclination of a length direction of the conductive section (13) with respect to the touch surface of the touch panel (2) is an angle (60 degrees to 90 degrees) at which a difference between a position of contact or proximity of the pen tip (12) on or to the touch surface and a center of gravity of a distribution of the sizes of changes in capacitance as generated by the pen tip (12) coming into contact with or proximity to the touch surface becomes constant regardless of place on the touch surface. With this, even when the pen tip is sufficiently small, variations in positions of contact or proximity to be detected when the pen body is tilted can be reduced.

### TECHNICAL FIELD

The present invention relates to information input pens and, in particular, to an information input pen for inputting information to a capacitive touch panel.

### BACKGROUND ART

Conventionally, a large number of schemes such as a resistive scheme, an infrared scheme, and an ultrasonic scheme have been known as schemes for touch panels. Among them, capacitive touch panels, which are widely employed in cellular phones, have recently been in the limelight.

A user's finger or an information input pen (hereinafter also referred to as “stylus pen”) is used to input information to a capacitive touch panel. Bringing the information input pen into contact with a touch surface of the touch panel causes a capacitance to be formed between an electrode inside the touch panel and the stylus pen. The touch panel detects a change in a small current flowing through the capacitance, thereby detecting the position of contact between the stylus pen and the touch surface.

Normally, an information input apparatus includes a touch panel and a display device that are integrated with each other by disposing a touch surface of the touch panel over a display surface of the display device. Such an information input apparatus allows a user to input information by touching a region on the display surface of the display device where objects such as operation buttons are displayed.

Different users hold a stylus pen in different ways. Some users hold it upright, and other users hold it at a tilt. A user trying to input information to a high-precision touch panel with a conventional stylus pen may end up with a failure, depending on how the user holds the pen. PTL 1 discloses that a high-precision touch panel that is capable of detecting a change in capacitance with high sensitivity may suffer from variations in touch positions to be detected, depending on the difference in the way of holding the stylus pen.

This problem is described below with reference to FIGS. 16 to 18. FIG. 16 is a diagram explaining a touch input to a conventional touch panel device disclosed in PTL 1. (a) of FIG. 16 shows a state where a touch input has been performed with a conventional stylus pen placed in a position vertical to a touch surface. (b) of FIG. 16 uses contour lines Lc1 to show a distribution of the sizes of changes in capacitance as detected in a touch position on the touch panel and an area around the touch position. (c) of FIG. 16 uses a graph GI to show the sizes S of the changes in capacitance in a horizontal direction.

FIG. 17 is a diagram explaining a touch input to the conventional touch panel device shown in FIG. 16. (a) of FIG. 17 shows a state where a touch input has been performed with the conventional stylus pen placed at a tilt with respect to the touch surface. (b) of FIG. 17 uses contour lines Lc2 to show a distribution of the sizes of changes in capacitance as detected in a touch position on the touch panel and an area around the touch position. (c) of FIG. 17 uses a graph G2 to show the sizes S of the changes in capacitance in a horizontal direction.

In the example shown in (a) of FIG. 16, a user performs a touch input with a stylus pen 200 placed in a position vertical to a touch surface 111 of a touch panel section 110. As shown in (b) of FIG. 16, a distribution of the sizes S of changes in capacitance as produced by this touch input is represented by the contour lines Lc1, which are symmetrical in a horizontal direction (X direction) and a vertical direction (Y direction) about an actual touch position RTp on the touch surface 111. In (b) of FIG. 16, Xp represents an axis parallel to the X direction that passes through the actual touch position RTp, Yp represents an axis parallel to the Y direction that passes through the actual touch position RTp, and Zp represents an axis perpendicular to the touch surface 111 that passes through the actual touch position RTp. The Xp axis and the Yp axis are orthogonal to each other.

In (c) of FIG. 16, the positions A1 and A2 are positions where the sizes of the changes in capacitance coincide with a predetermined threshold Sth. The touch panel section 111 calculates an intermediate point between these positions A1 and A2 as the X-direction coordinate Ax of a touch position. That is, Ax=(A1+A2)/2. The X-direction coordinate Ax of a detected touch position coincides with the X-direction coordinate of the actual touch position RTp.

In (a) of FIG. 17, the user performs a touch input with the stylus pen 200 placed at a leftward tilt with respect to the touch surface 111 of the touch panel section 110. In (a) of FIG. 17, Ox represents an angle of inclination of the stylus pen 200 with respect to the touch surface 111. In (a) of FIG. 17, the angle of inclination Ox is smaller than 90 degrees. A distribution of the sizes S of changes in capacitance as produced by this touch input is represented by the contour lines Lc2 in (b) of FIG. 17. As shown in (b) of FIG. 17, the contour lines Lc2 form figures that are asymmetrical in a horizontal direction (X direction). Specifically, the sizes S are more dense on the right side of a peak position Sp of the changes in capacitance, whereas the sizes S are more sparse on the left side of the peak position Sp.

In (c) of FIG. 17, the positions B1 and B2 are positions where the sizes of the changes in capacitance detected coincide with the predetermined threshold Sth. The touch panel section 111 calculates an intermediate point between these positions B1 and B2 as the X-direction coordinate Bx of a touch position. That is, Intermediate position Bx=(B1+B2)/2. As shown in (c) of FIG. 17, the X-direction coordinate Bx of a detected touch position deviates leftward from the X-direction coordinate of the actual touch position RTp.

As stated above, performing a touch input on the touch surface 111 with the conventional stylus pen 200 produces variation in touch positions to be detected, depending on the angle of inclination of the stylus pen 200 with respect to the touch surface 111. A reason for this is as follows. In the high-precision touch panel, changes in size of capacitance are produced by a conductor portion at a tip section of the stylus pen 200 that comes into proximity to the touch surface 11, as well as a pen tip that is in contact with the touch surface 111. A change in the angle of inclination of the stylus pen 200 leads to a change in size of a capacitance that is produced between the touch panel and the conductor portion. This also causes a distribution of the sizes of changes in capacitance by the conductor portion to change according to the angle of inclination of the stylus pen such that the distribution becomes more asymmetrical as the angle of inclination becomes larger.

In order to solve this problem, PTL 1 discloses a stylus pen 100 shown in FIG. 18. FIG. 18 is a diagram showing the stylus pen 100 according to PTL 1. As shown in FIG. 18, the stylus pen 100 has a conductor provided as a spherical member 101 in a pen tip section and has non-conductors as the pen tip section 102 and a pen body section 103 provided around the spherical member 101 so that only the spherical member 101 is involved in a distribution of the sizes of changes in capacitance.

Advantages of this stylus pen 101 are described in PTL 1 as follows. Since the pen tip 101 of the stylus pen 100 is spherical, tilting the stylus pen 100 as shown in (b) of FIG. 18 causes a grounded part (touch position) of the pen tip 101 to be a central part of the conductor. This causes a distribution of the sizes of changes in capacitance to be symmetrical with respect to an actual touch position, with the result that there are no variations in touch positions even when the stylus pen 100 is tilted.

### CITATION LIST

### Patent Literature

PTL 1: Japanese Unexamined Patent Application Publication No. WO 2013/057862 (Publication Date: Apr. 25, 2013)

### SUMMARY OF INVENTION

### Technical Problem

Manufacturing of the stylus pen 100 of PTL 1 requires attaching the spherical pen 101 tip to the pen body, which is a non-conductor, and, furthermore, providing a conducting wire 105 via which a contact member 104, which is provided in a grip of the pen body, and the pen tip 101 are connected, in order that a hand gripping the pen body and the pen tip 101 become electrically continuous. This poses a problem in terms of ease of processing. For easier processing, it is conceivable to process the tip of the conducting wire into a conical shape without providing the spherical member 101. However, the processing of the pen tip into a conical shape allows the conducting wire 105 to influence a distribution of the sizes of changes in capacitance as produced by contact of the pen tip 101, thus leading to recurrence of the problem of the distribution becoming asymmetrical with respect to the touch position according to the angle of inclination of the pen.

Further, the influence of the conducting wire 105 on the distribution of the sizes of the changes in capacitance is ignorable if the spherical pen tip 101 is sufficiently larger than the conducting wire 105. However, if the pen tip 101 is too large, the touch panel comes to detect touch positions at too wide intervals. Making the spherical pen tip 101 sufficiently smaller to narrow these intervals of detection makes the influence of the conducting wire 105 on the distribution unignorable, thus leading to recurrence of the problem of the distribution becoming asymmetrical with respect to the actual touch position.

The present invention is one made to solve the aforementioned problem. It is an object of the present invention to provide an information input pen by which variations in positions of contact or proximity to be detected when a pen body is tilted can be reduced even when a pen tip is sufficiently small.

### Solution to Problem

In order to solve the problem, an information input pen according to the present invention is an information input pen for inputting information to a capacitive touch panel, including:

a non-conductive pen body;

a conductive pen tip; and

a conductive section electrically connected to the pen tip and obliquely disposed with respect to a length direction of the pen body,

wherein when the pen tip comes into contact with or proximity to a touch surface of the touch panel, an angle of inclination of a length direction of the conductive section with respect to the touch surface of the touch panel is a predetermined angle at which a difference between a position of contact or proximity of the pen tip on or to the touch surface and a center of gravity of a distribution of sizes of changes in capacitance as generated by the pen tip coming into contact with or proximity to the touch surface becomes constant regardless of place on the touch surface.

### Advantageous Effects of Invention

An aspect of the present invention brings about such an effect that variations in positions of contact or proximity to be detected when the pen body is tilted can be reduced even when the pen tip is sufficiently small.

### BRIEF DESCRIPTION OF DRAWINGS

FIG. 1 is a perspective view showing the main components of a touch input system according to Embodiment 1 of the present invention.

FIG. 2 is a block showing the main components of a touch panel that constitutes the touch input system according to Embodiment 1 of the present invention.

FIG. 3 is a diagram showing the main components of a stylus pen that constitutes the touch input system according to Embodiment 1 of the present invention.

FIG. 4 is a diagram showing an example of a relationship between the angle of inclination of a pen body and the angle of inclination of a conductive section with respect to a touch surface of the touch panel in Embodiment 1 of the present invention.

FIG. 5 is a diagram explaining a problem that arises in a case where a conventional stylus pen is tilted at 30 degrees with respect to the touch surface of the touch panel.

FIG. 6 is a diagram explaining a problem that arises in a case where the conventional stylus pen is tilted at 45 degrees with respect to the touch surface of the touch panel.

FIG. 7 is a diagram explaining a problem that arises in a case where the stylus pen according to the present embodiment is tilted at 30 degrees with respect to the touch surface of the touch panel.

FIG. 8 is a diagram showing a relationship between the inclination of the conventional stylus pen and a positional shift of the center of gravity with respect to the mesh spacing of the touch panel.

FIG. 9 is a perspective view showing the main components of a touch input system according to Embodiment 2 of the present invention.

FIG. 10 is a diagram showing the main components of a stylus pen and a touch panel that constitute the touch input system according to Embodiment 2 of the present invention.

FIG. 11 is a diagram showing a state where the stylus pen is to be detected by the touch panel in Embodiment 2 of the present invention.

FIG. 12 is a diagram showing a state where the stylus pen has been detected by the touch panel in Embodiment 2 of the present invention.

FIG. 13 is a perspective view showing the main components of a touch input system according to Embodiment 3 of the present invention.

FIG. 14 is a diagram showing the main components of a stylus pen and a touch panel that constitute the touch input system according to Embodiment 3 of the present invention.

FIG. 15 is a diagram showing how the stylus pen according to an embodiment of the present invention adjusts the inclination of the conductive section according to a bias in a distribution of the sizes of changes in capacitance.

FIG. 16 is a diagram explaining a touch input to a conventional touch panel device disclosed in PTL 1.

FIG. 17 is a diagram explaining a touch input to the conventional touch panel device shown in FIG. 16.

FIG. 18 is a diagram showing a stylus pen according to PTL 1.

### DESCRIPTION OF EMBODIMENTS

### Embodiment 1

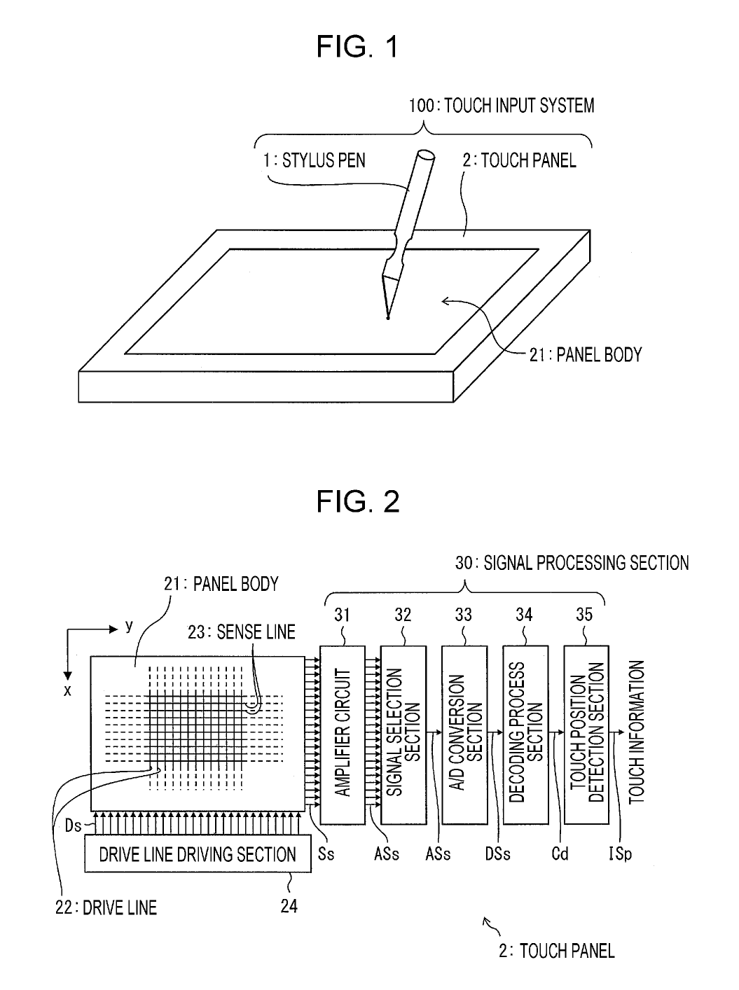

Embodiment 1 of the present invention is described below with reference to FIGS. 1 to 8.

(Configuration of Touch Input System 100)

FIG. 1 is a perspective view showing the main components of a touch input system 100 (information input system) according to the present embodiment. As shown in FIG. 1, the touch input system 100 includes a stylus pen 1 (information input pen) and a capacitive touch panel 2. A user performs a touch input (touch operation) on the touch panel 2 by bringing the stylus pen 1 into contact with or proximity to a touch surface of the touch panel 2. The touch panel 2 is integrated with a display device (not illustrated) such that the touch surface of the touch panel 2 is disposed over a display surface of the display device.

The information input apparatus, whose touch panel 2 and display device are integrated with each other, allows a user to input information by touching a region on the display surface of the display device where objects such as operation buttons are displayed.

(Configuration of Touch Panel 2)

FIG. 2 is a block showing the main components of the touch panel 2. As shown in FIG. 2, the touch panel 2 includes a panel body 21 having a plurality of drive lines 22 and a plurality of sense lines 23, a drive line driving section 24 that applies driving signals Ds to the drive lines 22 of the panel body 21, and a signal processing section 30 that receives, from the sense lines 23, sense signals Ss produced by the application of the driving signals Ds and generates touch information ISp corresponding to the sense signals Ss.

The signal processing section 30 includes an amplifier circuit 31, a signal selection section 32, an AID conversion section 33, a decoding process section 34, and a touch position detection section 35. The amplifier circuit 31 amplifies the sense signals Ss sent from the plurality of sense lines 23. The signal selection section 32 selects the amplified sense signals ASs in sequence and outputs the selected amplified sense signal ASs. The A/D conversion section 33 converts the outputted amplified sense signal ASs into a digital signal DSs. The decoding process section 34 decodes the obtained digital signal DSs with use of converted signals for decoding based on series signals used in the generation of the driving signals Ds and acquires a signal strength Cd corresponding to the sizes of changes in capacitance at points of intersection of the drive lines 22 and the sense lines 23 in the panel body 21. The touch position detection section 35 calculates a distribution of the sizes of the changes in capacitance in the panel body 21 on the basis of the signal strength Cd and generates the touch information ISp, which indicates a touch position by the user on the panel body 21, on the basis of the center of gravity of the distribution, thereby detecting a touch position on the touch surface.

In the touch panel 2, the plurality of chive lines 22 arranged parallel to one another and the sense lines 23 arranged parallel to one another are arranged to achieve a two-level crossing. The plurality of drive lines 22 and the plurality of sense lines 23 form a matrix pattern of electrodes. The point of intersection of at least each of the drive lines 22 and the corresponding one of the sense lines 23 is insulated. At each of the points of intersection, a capacitance between the corresponding one of the drive lines 22 and the corresponding one of the sense lines 23 is generated. When a grounded conductive indicator (a finger or the stylus pen 1) comes into contact with or proximity to the touch surface of the touch panel 2, charges between chive lines 22 and sense lines 23 in an area near the indictor are transferred toward the ground through the indicator. This leads to decreases in capacitance in the area near the indicator. By measuring the sizes of these changes in capacitance, the touch panel 2 detects a touch position (position of contact) or a position of proximity of the indicator on or to the touch surface. In the present embodiment, by measuring a distribution of the sizes of changes in capacitance and calculating the center of gravity of the distribution, the touch panel 2 can also detect a touch position or a position of proximity at a point other than the points of intersection.

(Configuration of Stylus Pen 1)

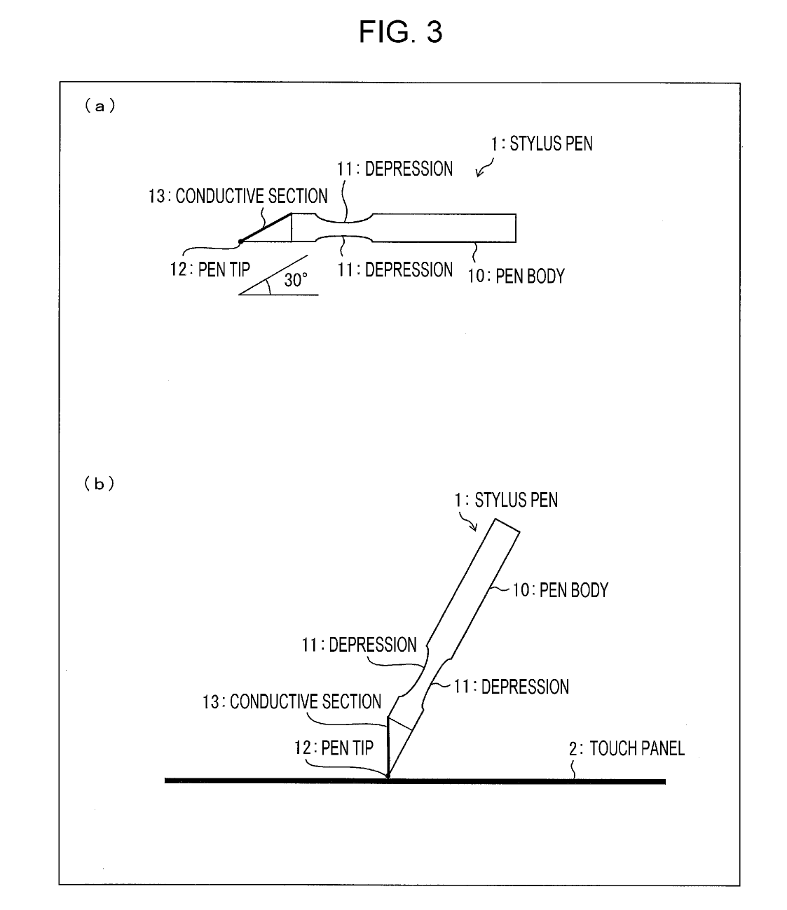

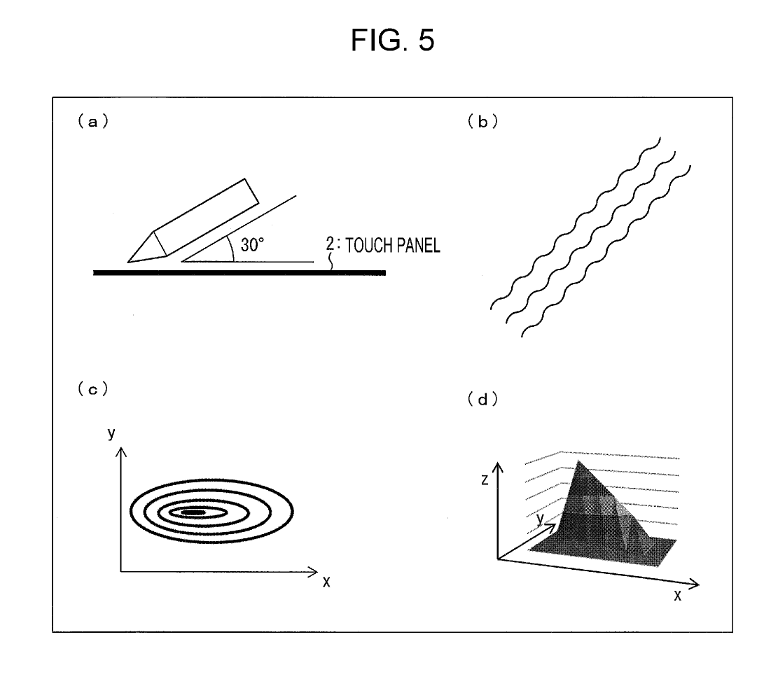

FIG. 3 is a diagram showing the main components of the stylus pen 1. As shown in (a) of FIG. 5, the stylus pen 1 includes a pen body 10, a pen tip 12, and a conductive section 13. The pen body 10 is made of a non-conductive material. Meanwhile, the pen tip 12 and the conductive section 13 are both made of a conductive material. The pen body 10 has an inclined surface inclined at 30 degrees with respect to a length direction of the stylus pen 1 and the conductive section 13 is provided on this inclined surface. This causes the conductive section 13 to be obliquely disposed with respect to a length direction of the pen body 10 and, more specifically, to be inclined at 30 degrees with respect to the length direction of the pen body 10. In other words, the length direction of the stylus pen 1 forms an angle of 30 degrees with a length direction of the conductive section 13. The conductive section 13 has an end electrically connected to the pen tip 12.

The pen body 10 has a plurality of depressions 11 formed in a part thereof by which the stylus pen 1 is gripped. These depressions 11 have shapes that fit the user's fingers when the user grips the stylus pen 1. When the user naturally grips the stylus pen 1 in such a manner that his/her fingers fit the plurality of depressions, the conductive section 13 comes to the upper side (front side) of the stylus pen 1.

A conductor portion (not illustrated) is provided as a portion of the part by which the user grips the stylus pen 1. The conductive section 13 plays the role of a conducting wire that, by electrically connecting this conductor portion to the pen tip 12, grounds the stylus pen 1 via a human body and transfers capacitances inside the touch panel 2 toward the ground. It is desirable that this conductor portion be provided in the depressions 11.

In the present embodiment, unlike in the conventional example, the pen tip 12 is small; therefore, changes in capacitance that appear in the touch panel 2 are mostly attributable to the conductor portion that is present at the tip of the stylus pen 1. In the case of the present embodiment, the conductor that is present at the tip of the stylus pen 1 corresponds to the pen tip 12 and the conductive section 13. Since the conductive section 13 is sufficiently larger in length than the pen tip 12, the influence on a distribution to be measured of the sizes of changes in capacitance is mostly occupied by the influence based on the angle of inclination of the conductive section 13 with respect to the touch surface.

As shown in (a) of FIG. 3, during use, the stylus pen 1 is inclined at a given angle with respect to the touch surface of the touch panel 2. Since the conductive section 13 is inclined at 30 degrees with respect to the length direction of the stylus pen 1, the pen body 10 and the conductive section 13 are inclined at different angles with respect to the touch surface.

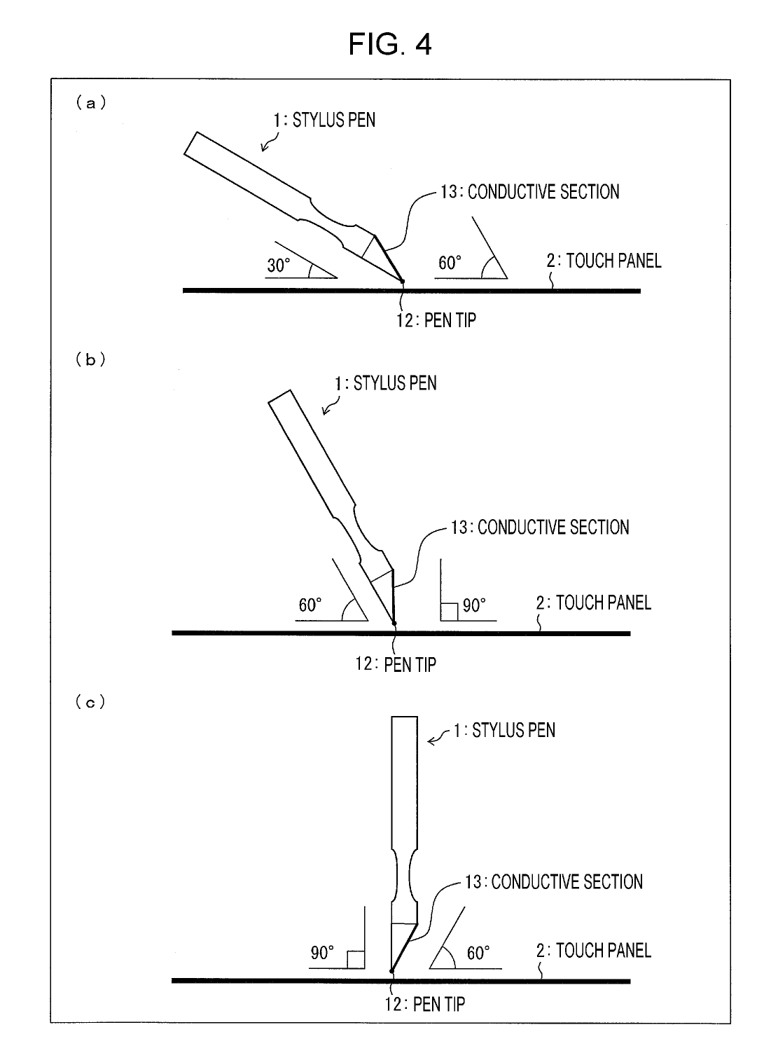

FIG. 4 is a diagram showing an example of a relationship between the angle of inclination of the pen body 10 and the angle of inclination of the conductive section 13 with respect to the touch surface.

In (a) of FIG. 4, the stylus pen 1 is tilted so that the angle of inclination of the pen body 10 with respect to the touch surface is 30 degrees. At this point in time, the angle of inclination of the conductive section 13 with respect to the touch surface is 60 degrees. That is, the conductive section 13 is tilted at 30 degrees with respect to a direction perpendicular to the touch surface.

In (b) of FIG. 4, the stylus pen 1 is tilted so that the angle of inclination of the pen body 10 with respect to the touch surface is 60 degrees. At this point in time, the angle of inclination of the conductive section 13 with respect to the touch surface is 90 degrees. That is, the conductive section 13 is not tilted at all with respect to the direction perpendicular to the touch surface. In other words, the conductive section 13 stands upright with respect to the touch surface.

In (c) of FIG. 4, the stylus pen 1 stands upright so that the angle of inclination of the pen body with respect to the touch pen is 90 degrees. At this point in time, the angle of inclination of the conductive section 13 with respect to the touch surface is 60 degrees. Therefore, the conductive section 13 is tilted at 30 degrees with respect to the direction perpendicular to the touch surface.

As shown in (a) to (c) of FIG. 4, in the stylus pen 1, when the pen tip 12 comes into contact with the touch surface of the touch panel 2a, the angle of inclination of the conductive section 13 with respect to the touch surface ranges from 60 degrees to 90 degrees (60 degrees or larger and 90 degrees or smaller) in the range of 30 degrees to 90 degrees of the angle of inclination of the pen body 10 with respect to the touch surface. In other words, the angle of inclination of the conductive section 13 with respect to the direction perpendicular to the touch surface ranges from 0 degree to 30 degrees. As will be described in detail later, in a case where the conductive section 13 is tilted at an angle falling within this range, a difference between an actual touch position (or position of proximity) of the pen tip 12 on or to the touch surface and the center of gravity of a measured distribution of the sizes of changes in capacitance becomes constant regardless of place on the touch surface. This makes it possible to reduce the influence of the conductive section 13 on the distribution of the sizes of the changes in capacitance, thus making it possible to reduce variations in touch positions (or positions of proximity) to be detected.

Further, as shown in (a) of FIG. 4, the angle of inclination of the conductive section 13 with respect to the direction perpendicular to the touch surface is as small as 30 degrees even when the angle of inclination of the stylus pen 1 with respect to the direction perpendicular to the touch surface is made larger. Therefore, even in a case where the stylus pen 1 is greatly tilted with respect to the direction perpendicular to the touch surface, variations in touch positions to be detected can be reduced.

Furthermore, with consideration for the influence of the conductive section 13 on the distribution to be measured of the sizes of changes in capacitance, the stylus pen 1, unlike the stylus pen disclosed in PTL 1, eliminates the need to make the pen tip 12 larger to reduce the influence. Therefore, even when the pen tip 12 is sufficiently small, variations in touch detection to be detected when the stylus pen 1 is greatly tilted can be reduced.

(Comparison of Paths)

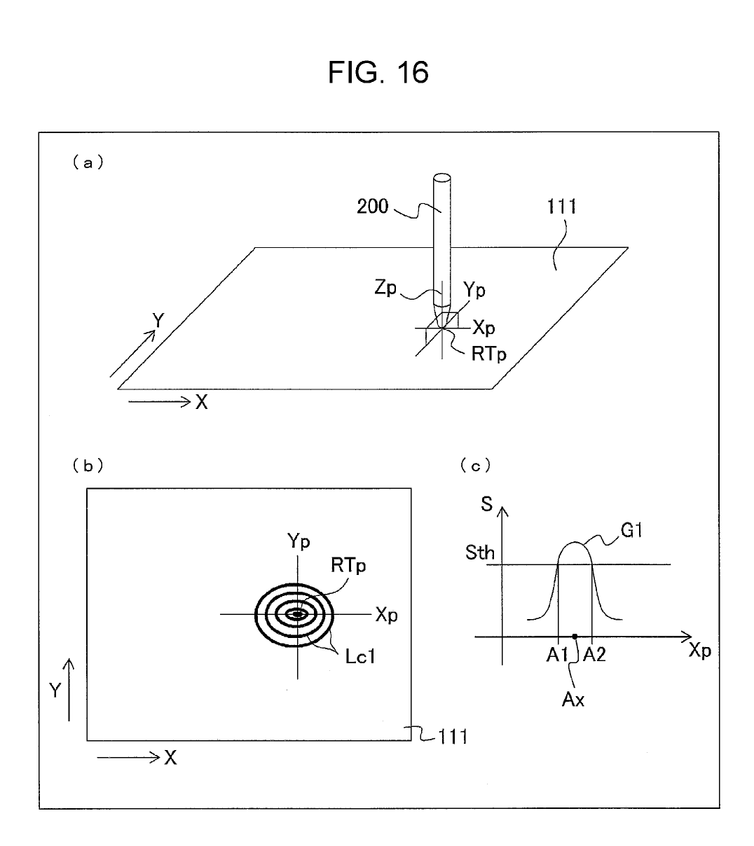

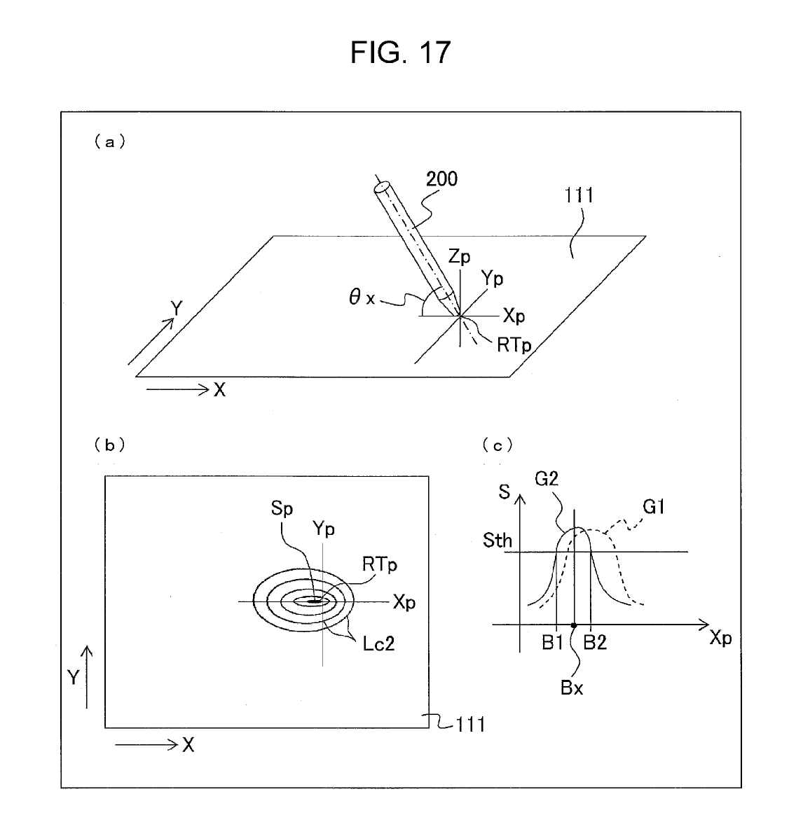

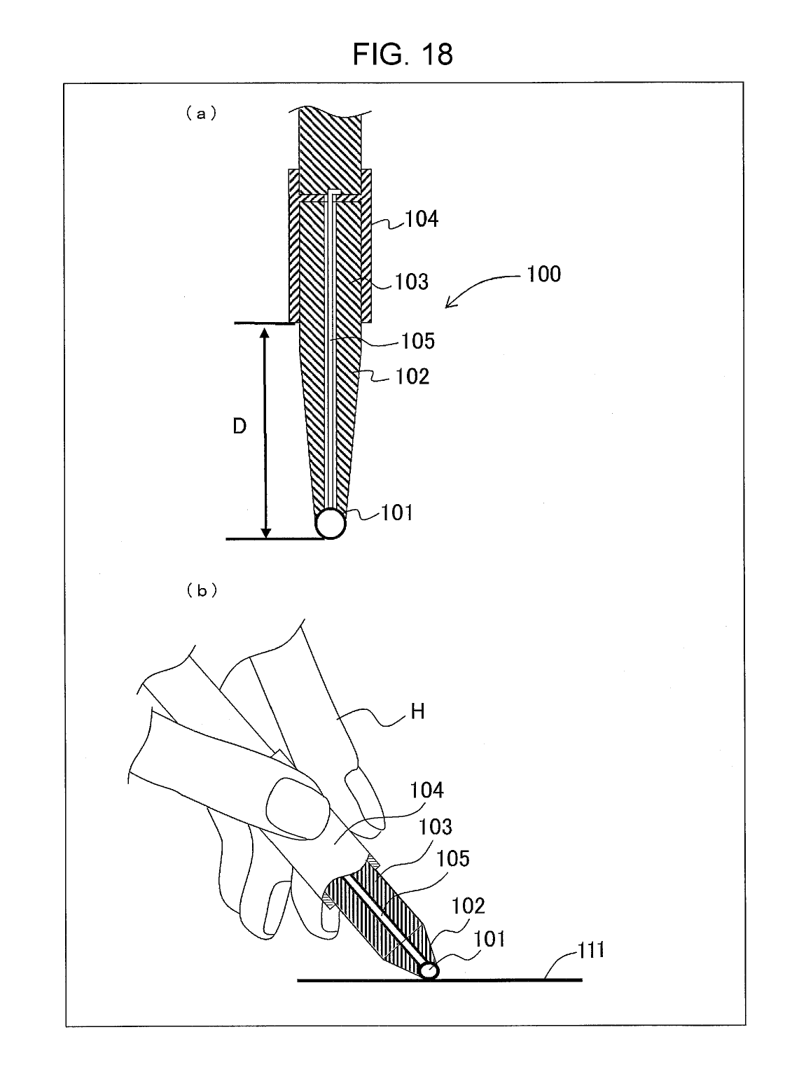

Greatly tilting a conventional stylus pen with respect to the direction perpendicular to the touch surface undesirably causes the pen tip to leave a jagged path on the touch panel 2. Meanwhile, the stylus pen 1 according to the present embodiment does not produce such a problem. A reason for that is given below with reference to FIGS. 5 to 7. It should be noted that the term “conventional stylus pen” as used herein means a stylus pen made entirely of a conductor, like the one shown in FIGS. 16 and 17.

FIG. 5 is a diagram explaining a problem that arises in a case where the conventional stylus pen is tilted at 30 degrees with respect to the touch surface of the touch panel 2. In the example shown in FIG. 5, the user moves the stylus pen along the touch surface of the touch panel 2 while tilting the stylus pen at 30 degrees with respect to the touch surface. At this point in time, the angle of inclination of the stylus pen with respect to the direction perpendicular to the touch surface is 60 degrees. In this case, there are variations in touch detection positions of the pen tip on the touch panel 2; therefore, even if the pen tip moves in a linear fashion, the pen tip leaves a jagged path as shown in (b) of FIG. 5.

This is because, as shown in (c) of FIG. 5, the widening of the detection range of the conductor portion leads to the widening of the range of appearance of changes in capacitance. A distribution of the sizes of the changes in capacitance in the range shown in (c) of FIG. 5 is shown in (d) of FIG. 5. As shown in (c) and (d) of FIG. 5, this distribution has a shape that is greatly asymmetrical in an x direction. This asymmetry produces a difference (i.e. positional discrepancy) between an actual touch position and the center of gravity of a calculated distribution.

The touch panel is not constant in capacitance across the touch surface, but slightly varies in capacitance from place to place on the touch surface. For this reason. even if the range of appearance of changes in capacitance in one place is identical to the range of appearance of changes in capacitance in another place, distributions of the sizes of the changes in the respective places are not always identical to each other.

When the range of appearance of changes in capacitance in the touch panel 2 is made larger by greatly tilting the conventional stylus pen with respect to the direction perpendicular to the touch surface, the center of gravity of the distribution to be calculated is very far away from the actual touch position on the touch surface. Even if the pen tip moves over the touch surface, a display that reproduces the movement of the pen tip can be performed even if the path of a touch input is displayed at the center of gravity calculated, as long as the difference between the actual touch position and the center of gravity to be calculated is constant. However, since the range of distributions to be detected varies from place to place due to the influence of differences in capacitance of the touch panel from place to place, the difference between the actual touch position of the pen tip and the center of gravity to be calculated varies from place to place. This makes it impossible to display the movement of the pen tip with fidelity, resulting in a jagged path as shown in (b) of FIG. 5.

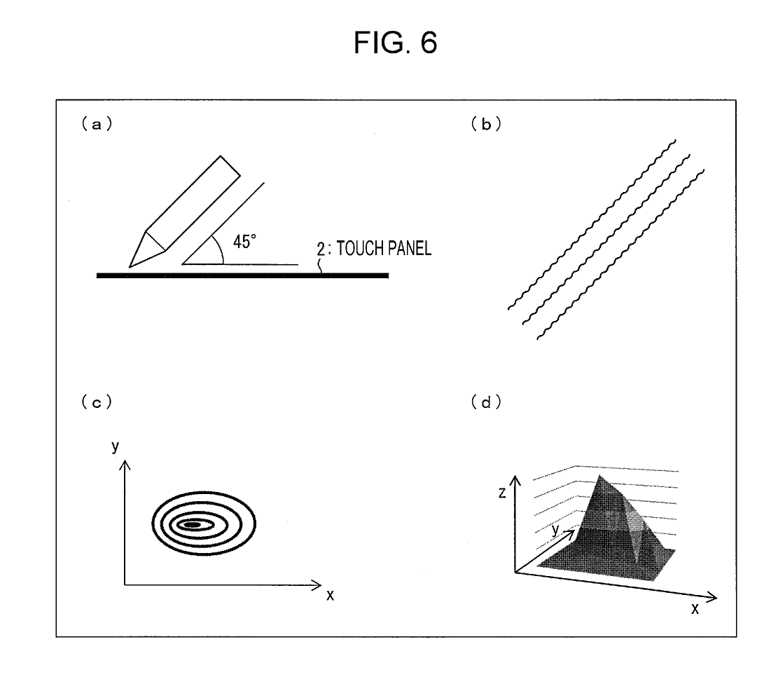

FIG. 6 is a diagram explaining a problem that arises in a case where the conventional stylus pen is tilted at 45 degrees with respect to the touch surface of the touch panel 2. In the example shown in FIG. 6, the angle of inclination of the stylus pen with respect to the direction perpendicular to the touch surface is 45 degrees. In this case, as shown in (b) of FIG. 6, the stylus pen still leaves a jagged path.

This is because, as shown in (c) of FIG. 6, the widening of the detection range of the conductor portion leads to the widening of the range of appearance of changes in capacitance. A distribution of the sizes of the changes in capacitance in the range shown in (c) of FIG. 6 is shown in (d) of FIG. 6. As shown in (c) and (d) of FIG. 6, this distribution has a shape that is asymmetrical in the x direction. This asymmetry produces a positional discrepancy between an actual touch position and the center of gravity of a calculated distribution, and since such positional discrepancies vary from place to place on the touch surface, the path is jagged as shown in (b) of FIG. 6. In the example shown in FIG. 6, since the angle of inclination of the stylus pen with respect to the direction perpendicular to the touch surface is smaller than that in the example shown in FIG. 5, the degree of jaggedness is smaller, but jaggedness still remains a problem.

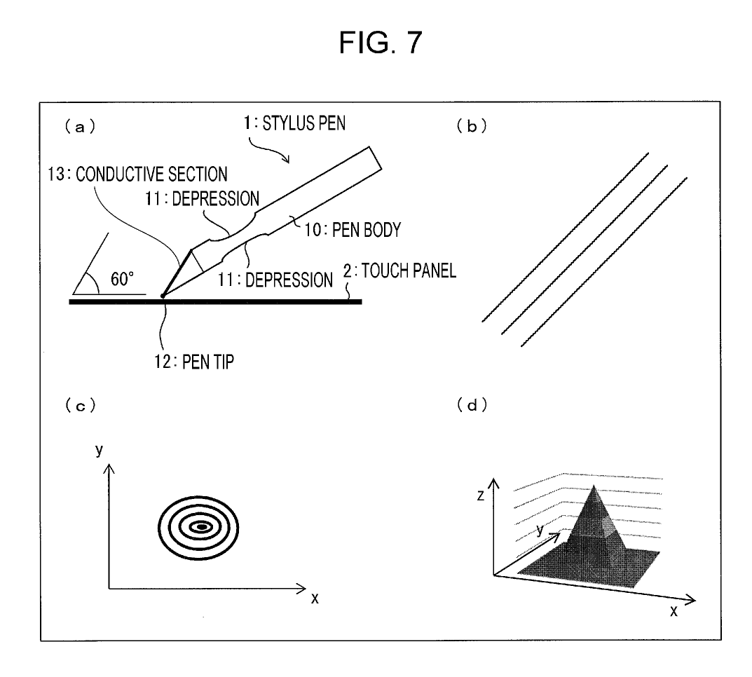

FIG. 7 is a diagram explaining a problem that arises in a case where the stylus pen 1 according to the present embodiment is tilted at 30 degrees with respect to the touch surface of the touch panel 2. In the example shown in FIG. 7, the user moves the stylus pen 1 along the touch surface of the touch panel 2 while tilting the stylus pen 1 at 30 degrees with respect to the touch surface. At this point in time, the angle of inclination of the stylus pen with respect to the direction perpendicular to the touch surface is 60 degrees. In the stylus pen 1, since the angle of inclination of the conductive section 13 with respect to the length direction of the stylus pen 1 is 30 degrees, the conductive section 13 is inclined at 60 degrees with respect to the touch surface. That is, the angle of inclination of the conductive section 13 with respect to the direction perpendicular to the touch surface is 30 degrees.

This case yields constant results of detection of the pen tip on the touch panel 2, resulting in not a jagged but a smooth path as shown in (b) of FIG. 7. This is because, as shown in (c) of FIG. 7, since the conductive section 13 is not tilted much with respect to the direction perpendicular to the touch surface, the detection range of the conductive section 13 does not become larger, with the result that the range of appearance of changes in capacitance becomes narrower. A distribution of the sizes of the changes in capacitance in the range shown in (c) of FIG. 7 is shown in (d) of FIG. 7. As shown in (c) and (d) of FIG. 7, this distribution has a shape that is symmetrical in the x direction. Since the distribution is symmetrical, there is no positional discrepancy between the actual touch position and the center of gravity of a detected distribution, with the result that a smooth path is achieved as shown in (b) of FIG. 7.

As mentioned above, when the angle of inclination of the conductive section 13 with respect to the direction perpendicular to the touch surface is smaller, the range of appearance of changes in capacitance in the touch panel 2 becomes narrower. This makes the difference between the center of gravity to be calculated and the actual touch position smaller. As long as the range of appearance of changes in capacitance is narrower, the difference between the center of gravity to be calculated and the actual touch position only slightly varies from place to place, even if a measured distribution of the sizes of changes in capacitance changes due to the influence of differences in capacitance of the touch panel from place to place. This is substantially tantamount to saying that the difference is constant regardless of place on the touch surface. Therefore, even if the stylus pen 1 according to the present embodiment is used while being tilted at 60 degrees as shown in (a) FIG. 7 with respect to the touch surface of the touch panel 2, the path of touch positions to be displayed is, as shown in (b) of FIG. 7, a smooth one that reproduces the movement of the pen tip 12 with fidelity.

In the touch input system 100 according to the present embodiment, saying that the difference between the center of gravity calculated and the actual touch position of the pen tip 12 is constant regardless of place on the touch surface is synonymous with saying that even if the difference between the center of gravity calculated and the actual touch position differs from place to place on the touch surface, the difference between a difference in one place and a difference in another place is equal to or smaller than a minimum recognition unit (minimum display unit) on the display surface.

(Relationship Between Mesh Spacing and Positional Shift)

As mentioned above, a positional shift of the center of gravity of a distribution occurs because the area of the conductor portion of the tilted stylus pen to be detected by the touch panel influences the shape of a distribution of the sizes of changes in capacitance in the touch panel and makes the distribution asymmetrical. This problem differs in degree according to the mesh spacing between capacitances in the touch panel.

A capacitive touch panel has capacitances formed at regular spacings called mesh spacings. In measuring a distribution of the sizes of changes in capacitance and calculating the center of gravity of the distribution, the touch panel uses the spreading of the distribution within a certain region within the touch surface for the calculation. A touch panel with a smaller mesh spacing experiences changes in capacitance at larger number of points of intersection included in a certain region than does a touch panel with a larger mesh spacing. Therefore, a touch panel with a smaller mesh spacing can calculate the center of gravity with use of more data and can therefore average the influence of differences in capacitance from place to place on the touch panel. As a result, an error between the position of the pen tip and the center of gravity as generated by the inclination of the stylus pen does not greatly vary even in the event of a change in place of touch.

Meanwhile, a touch panel with a larger mesh spacing needs to find the center of gravity with use of less data and is therefore greatly influenced by differences in capacitance from place to place on the touch panel. This produces such a problem that a difference between the position of the pen tip and the center of gravity as generated by the inclination of the stylus pen greatly varies in the event of a change in place of touch.

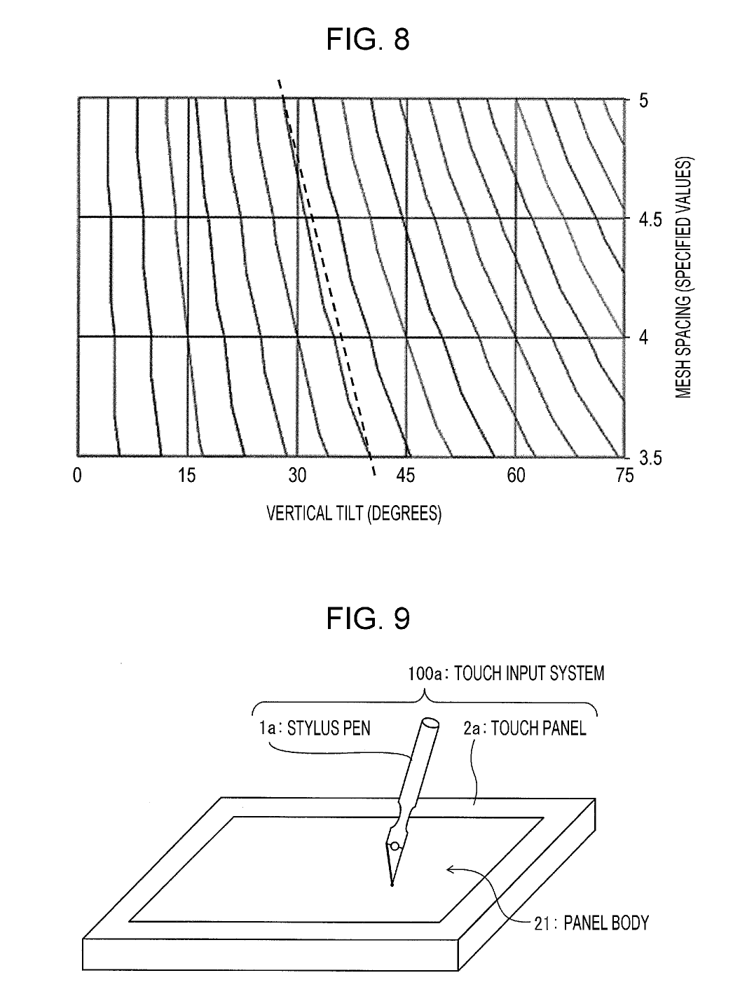

FIG. 8 is a diagram showing a relationship between the inclination of the conventional stylus pen and a positional shift of the center of gravity with respect to the mesh spacing of the touch panel. In FIG. 8, the horizontal axis represents the inclination of the stylus pen, and the horizontal axis represents the mesh spacing. A distribution of positional shifts of the center of gravity is represented by contour lines. The vertical axis represents, as specified values, the common range of mesh spacings in the touch panel which correspond to pen touch detection. In other words, the mesh spacings in the touch panel for pen touch detection falls within the range represented by the vertical axis in FIG. 8.

As shown in FIG. 8, the positional shift of the center of gravity becomes larger in a case where the angle of inclination of the stylus pen 1 with respect to the direction perpendicular to the touch surface is larger. Further, the positional shift of the center of gravity also becomes larger in a case where the mesh spacing is larger. When the angle of inclination of the stylus pen with respect to the direction perpendicular to the touch surface is large, the touch panel detects an increase in the area of the conductor portion as generated by the inclination of the stylus pen 1. Meanwhile, when the mesh spacing is larger, there is a larger error between the actual position of the pen tip touched and the center of gravity of a distribution of the sizes of changes in capacitance detected.

In FIG. 8, the dotted line indicates a boundary line of the positional shift of the center of gravity at which the touch panel can assure reproduction of the path of the stylus pen. Those of the contour lines in FIG. 8 which are on the left side of the dotted line indicate that reproduction of the path of the stylus pen can be assured. On the other hand, those of the contour lines in FIG. 8 which are on the right side of the dotted line indicate that reproduction of the path of the stylus pen cannot be assured. If the mesh spacing is small, reproduction of the path of the stylus pen can be assured in the range of 0 degree to approximately 40 degrees of the angle of inclination of the stylus pen with respect to the direction perpendicular to the touch surface. In contrast, if the mesh spacing is large, reproduction of the path of the stylus pen can be assured in the range of 0 degree to a little less than 30 degrees of the angle of inclination of the stylus pen with respect to the touch surface.

Even with the mesh spacing being equal, the magnitude of noise that influences the sizes of changes in capacitance to be detected differ according to the pattern shapes and materials of the drive lines and the sense lines and the thickness of cover glass. With the influence of these noises taken into account, FIG. 8 shows a boundary line in a touch panel having such pattern shapes, materials, and cover glass thickness that the noise is worst. With this excess margin taken into account, it is found that, in a touch panel for pen touch detection, reproduction of the path of the stylus pen can be assured regardless of mesh spacing, as long as the angle of inclination of the stylus pen with respect to the direction perpendicular to the touch surface is equal to or smaller than 30 degrees.

As shown in (a) to (c) of FIG. 4, the angle of inclination of the conductive section 13 with respect to the direction perpendicular to the touch surface ranges from 0 degree to 30 degrees within the range of ordinary use of the stylus pen 1 according to the present embodiment. Meanwhile, as shown in FIG. 8, reproduction of the path of the stylus pen can be assured regardless of mesh spacing, as long as the angle of inclination of the stylus pen, made entirely of a conductive material, with respect to the touch surface is equal to or smaller than 30 degrees with reference to the direction perpendicular to the touch surface. Therefore, the stylus pen 1 according to the present embodiment can assure reproduction of the path of touch positions on the touch surface within the range of ordinary use.

Further, since, when the user holds the stylus pen 1, the user's hand comes into contact with the conductor portion connected to the conductive section 13, the pen tip 12 and the conductive section 13 both become equal in potential (ground) to humans. This keeps the pen tip 12 and the conductive section 13 out of a floating situation, the distribution of the sizes of changes in capacitance becomes more stable. As a result, touch positions can be detected with a higher degree of accuracy.

### Embodiment 2

Embodiment 2 of the present invention is described below with reference to FIGS. 9 to 12.

FIG. 9 is a perspective view showing the main components of a touch input system 100a according to the present embodiment. As shown in FIG. 9, the touch input system 100a includes a stylus pen la (information input pen) and a capacitive touch panel 2a.

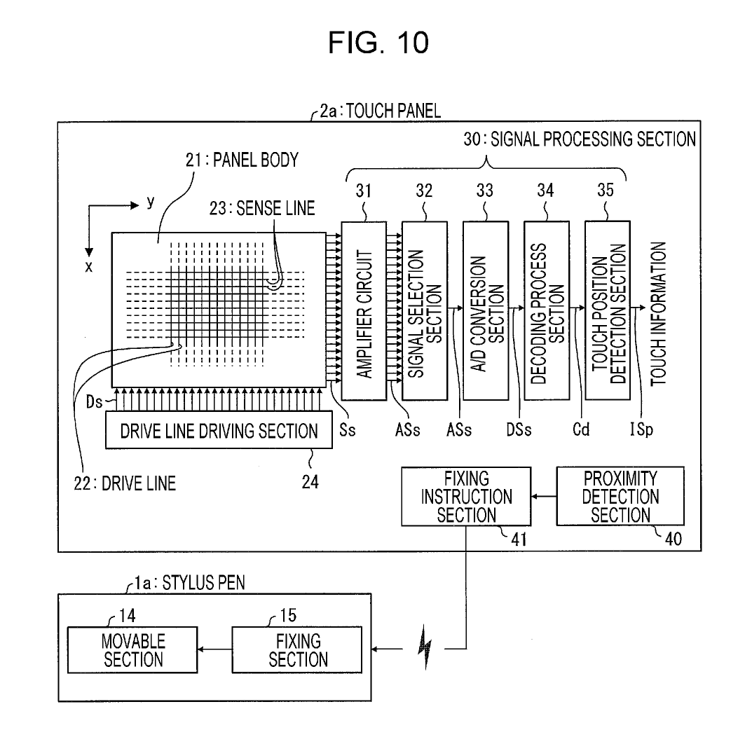

FIG. 10 is a diagram showing the main components of the stylus pen 1a and the touch panel 2a, which constitute the touch input system 100a according to the present embodiment. The stylus pen la further includes a movable section 14 and a fixing section 15 in addition to the members that the stylus pen 1 of Embodiment 1 includes. The touch panel 2a further includes a proximity detection section 40 and a fixing instruction section 41 in addition to the touch panel 2 of Embodiment 1.

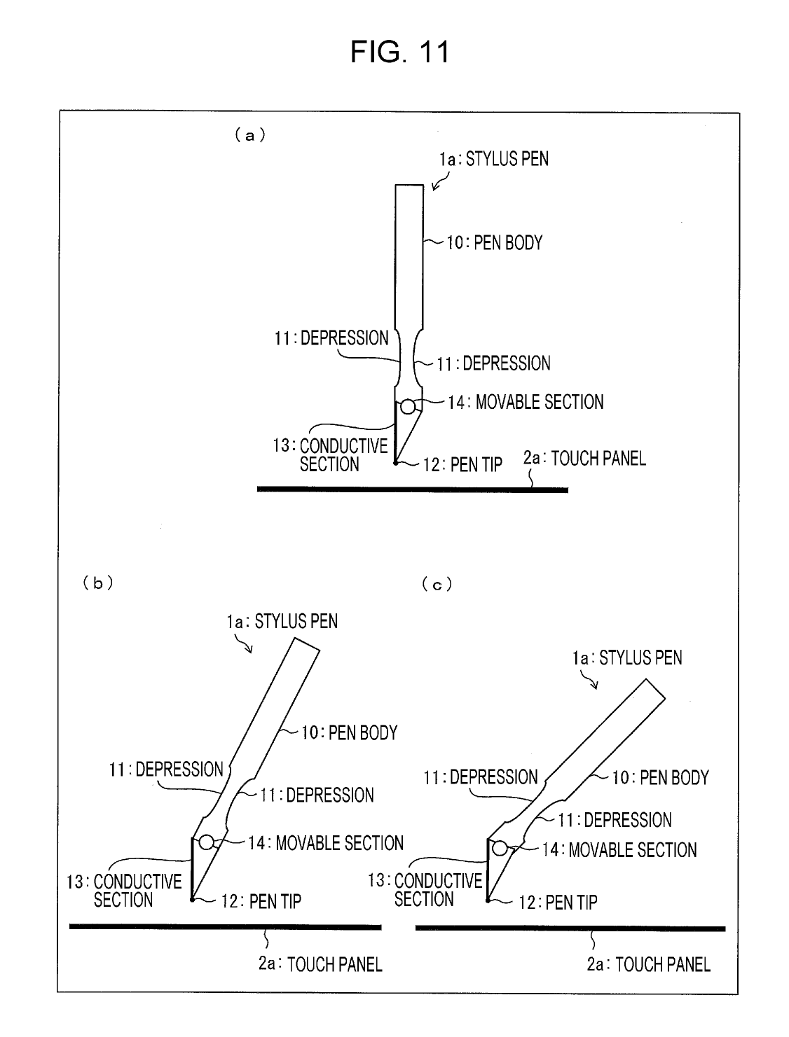

FIG. 11 is a diagram showing a state where the stylus pen 1a is to be detected by the touch panel 2a. As shown in FIG. 11, when the pen tip 12 of the stylus pen 1a is at a certain distance or longer from the touch surface of the touch panel 2a, the movable section 14 moves a part including the pen tip 12 and the conductive section 13. In other words, when the touch panel 2a does not detect proximity of the stylus pen la, the movable section 14 moves the conductive section 13 including the pen tip 12 and the conductive section 13 so that the angle of inclination of the length direction of the conductive section 13 with respect to the touch surface of the touch panel 2a becomes a predetermined angle at which the difference between the position of contact of the pen tip 12 on the touch surface and the center of gravity of the distribution of the sizes of changes in capacitance as generated by the pen tip 12 coming into contact with the touch surface becomes constant regardless of place on the touch surface (position of contact of the pen tip 12). As mentioned in Embodiment 1, the predetermined angle that satisfies this condition ranges, for example, from 60 degrees to 90 degrees.

In the example shown in (a) to (c) of FIG. 11, the pen tip 12 spontaneously faces the ground surface no matter what angle the pen body 10 is inclined at, and the part including the pen tip 12 and the conductive section 13 moves so that the conductive section 13 become parallel to the direction of gravitational force. At this point in time, the conductive section 13 stands upright with respect to the touch surface. That is, the length direction of the conductive section 13 font's an angle of 90 degrees with the touch surface.

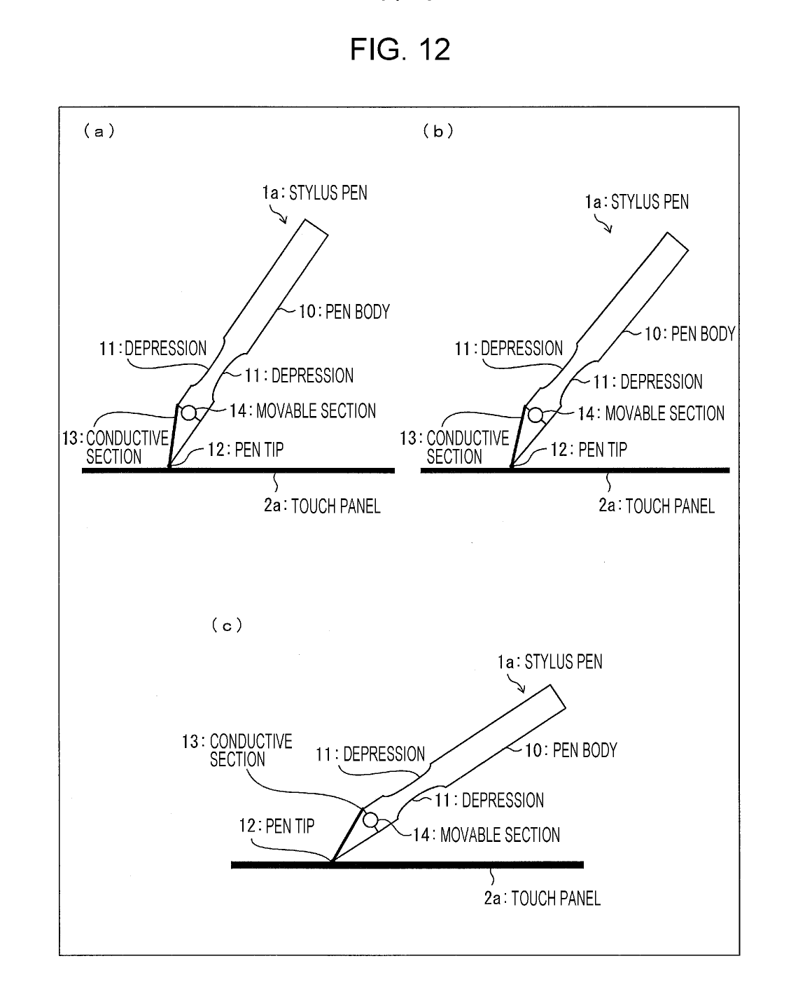

FIG. 12 is a diagram showing a state where the stylus pen la has been detected by the touch panel 2a. When the pen tip 12 of the stylus pen la comes within a certain distance of the touch surface of the touch panel 2a, the proximity detection section 40 provided in the touch panel 2a detects the proximity and notifies the fixing instruction section 41 of the proximity. The stylus pen la and the touch panel 2a are wirelessly communicable with each other, and upon receiving the notification from the proximity detection section 40, the fixing instruction section 41 notifies the stylus pen 1a that the pen tip 12 has been detected by the touch panel 2, and instructs the stylus pen la to fix the pen tip 12.

In the stylus pen la, the fixing section 15 receives this instruction. Upon receiving this instruction, the fixing section 15 instructs the movable section 14 to fix the part including the pen tip 12 and the conductive section 13. This allows the movable section 14 to fix the part including the pen tip 12 and the conductive section 13.

When the pen tip 12 of the stylus pen 1 a in the state shown in (b) of FIG. 11 is brought into contact with the touch surface of the touch panel 2a while this angle of inclination is maintained, the state of the stylus pen la becomes the one shown in (a) of FIG. 12. At this point in time, the part including the pen tip 12 and the conductive section 13 is fixed. Therefore, as shown in (b) or (c) of FIG. 12, the part including the pen tip 12 and the conductive section 13 does not move relative to the pen body 10 even if the stylus pen 1a is entirely further inclined toward the touch surface.

As mentioned above, before the stylus pen la is detected by the touch panel 2a, the length direction of the conductive section 13 stands upright with respect to the touch surface of the touch panel 2a. That is, the angle of inclination of the conductive section 13 with respect to the touch surface is 90 degrees. This causes the conductive section 13 to be fixed at an angle of inclination of 90 degrees with respect to the touch surface at a point in time where the pen tip 12 of the stylus pen la comes into contact with the touch panel 2a. After this, the stylus pen la may be further inclined with respect to the touch surface while the user continues to hold the touch panel 2a. However, since, in the range of ordinary use of the touch panel 2a, the stylus pen la is not greatly tilted at an angle exceeding 60 degrees with respect to the direction perpendicular to the touch surface, the angle of inclination of the conductive section 13 with respect to the touch surface is kept within the range of 60 degrees to 90 degrees during use of the stylus pen 1a.

Therefore, as with the stylus pen 1 of Embodiment 1, the stylus pen la according to the present embodiment makes it possible to reduce the influence of the conductive section 13 on a distribution of the sizes of changes in capacitance as generated by the pen tip 12. This makes it possible to, even when the pen tip 12 is sufficiently small, reduce variations in touch detection positions when the stylus pen 1a is tilted.

### Embodiment 3

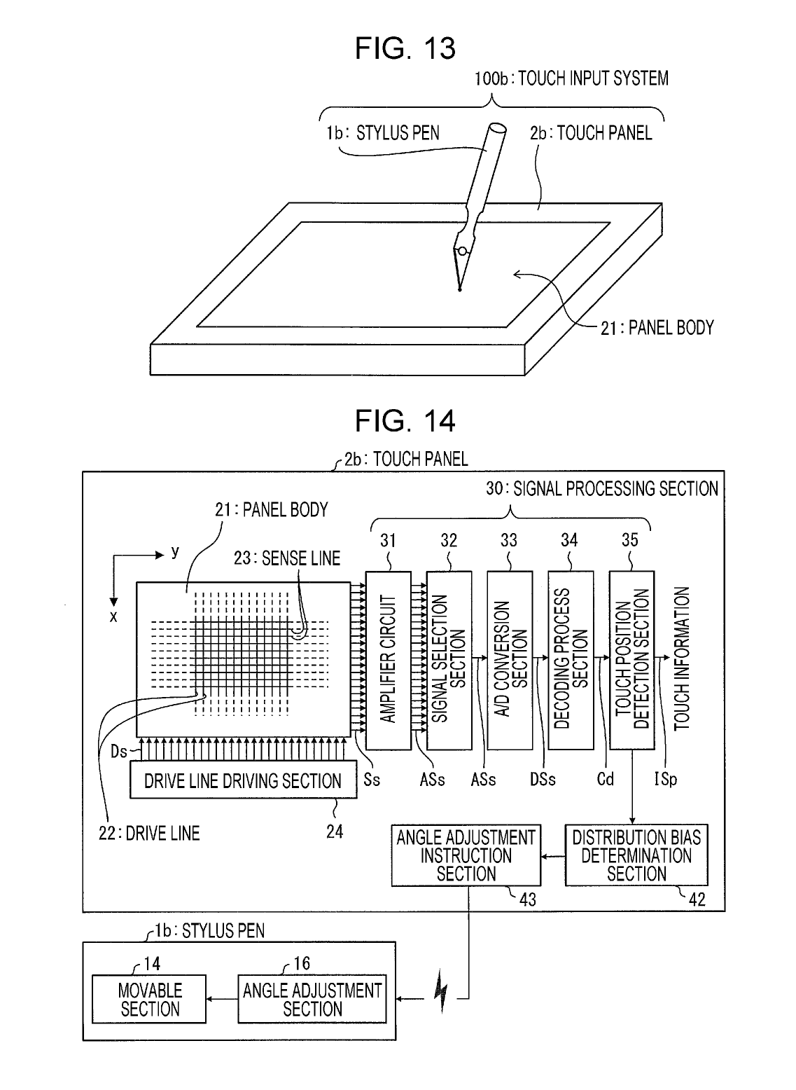

Embodiment 3 of the present invention is described below with reference to FIGS. 13 to 15.

FIG. 13 is a perspective view showing the main components of a touch input system 100b according to the present embodiment. As shown in FIG. 13, the touch input system 100b includes a stylus pen lb (information input pen) and a capacitive touch panel 2b.

FIG. 14 is a diagram showing the main components of the stylus pen 1b and the touch panel 2b, which constitute the touch input system 100b according to the present embodiment. The stylus pen lb further includes a movable section 14 and an angle adjustment section 16 in addition to the members that the stylus pen 1 of Embodiment 1 includes. The touch panel 2b further includes a distribution bias determination section 42 and an angle adjustment instruction section 43 in addition to the touch panel 2 of Embodiment 1.

In the stylus pen lb of the present embodiment, as in Embodiment 2, the movable section 14 can move a part including the pen tip 12 and the conductive section 13. In the present embodiment, the movable section 14 includes a stepping motor and a control circuit that function to adjust the angle of inclination of the part including the pen tip 12 and the conductive section 13 with respect to the pen body 10.

In the touch panel 2b, the touch position detection section 35 outputs, to the distribution bias determination section 42. data indicating a measured distribution of the sizes of changes in capacitance. The distribution bias determination section 42 determines whether a bias in the distribution exceeds a predetermined reference value, and notifies the angle adjustment instruction section 43 of a result of the determination. The stylus pen 1b and the touch panel 2a are wirelessly communicable with each other, and upon receiving the notification to the effect that the bias exceeds the reference value, the angle adjustment instruction section 43 transmits, to the stylus pen 1b, information indicating what direction the distribution is biased in along the x axis, and instructs the stylus pen 1b to adjust the angle of the pen tip 12 to be an angle that further reduces the bias in the distribution.

In the stylus pen 1b, the angle adjustment section 16 receives this information and this instruction. The angle adjustment section 16 controls the stepping motor and control circuit of the movable section 14 and thereby changes the angles of the pen tip 12 and the conductive section 13 to angles that further reduce the bias in the distribution.

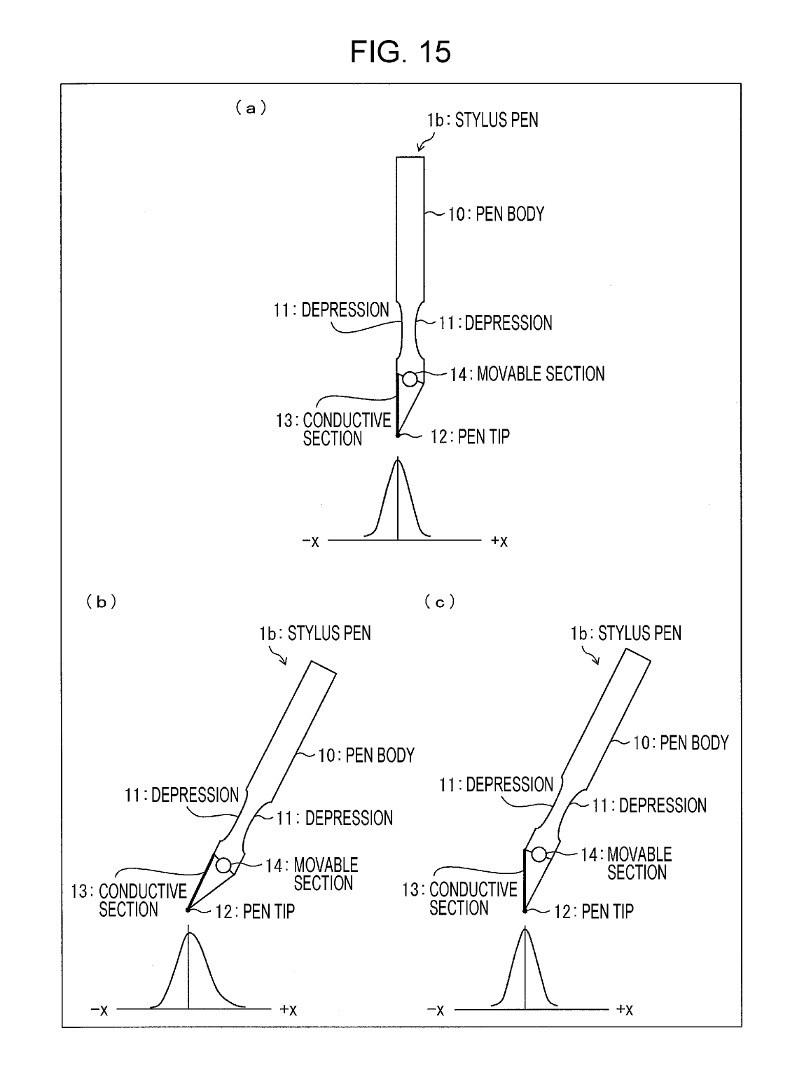

FIG. 15 is a diagram showing how the stylus pen 1b adjusts the inclination of the conductive section 13 according to a bias in a distribution of the sizes of changes in capacitance. FIG. 15 shows the stylus pen 1b in the upper part of (a) to (c) thereof and shows a distribution of the sizes of changes in capacitance in the lower part.

When the stylus pen 1b is in contact with the touch surface in the state shown in (a) of FIG. 15, there is no bias in the distribution to be measured of the sizes of changes in capacitance, as the length direction of the conductive section 13 is perpendicular to the touch surface. Therefore, the distribution bias determination section 42 determines that the bias in the distribution does not exceed the predetermined reference value, and notifies the angle adjustment instruction section 43 to that effect. In response, the angle adjustment instruction section 43 does not instruct the stylus pen 1b to makes an angle adjustment. Accordingly, the stylus pen lb does not adjust the angle of inclination of the conductive section 13.

Meanwhile, when the stylus pen lb is in contact with the touch surface in the state shown in (b) of FIG. 15, there is a bias in the distribution to be measured of the sizes of changes in capacitance, as the length direction of the conductive section 13 is inclined at a given angle with respect to the touch surface. In the example shown in (b) of FIG. 15, the distribution is biased in a +x direction along the x axis. The distribution bias determination section 42 determines that the bias in the distribution exceeds the predetermined reference value, and notifies the angle adjustment instruction section 43 to that effect. In response, the angle adjustment instruction section 43 notifies that the distribution is biased in the +x direction, and instructs the stylus pen 1b to adjust the angle of the conductive section 13. In response, the angle adjustment section 16 adjusts the angle of inclination of the conductive section 13 to be an angle that reduces the +x-direction bias in the distribution. Specifically the angle adjustment section 16 controls the movable section 14 so that the conductive section 13 becomes inclined at a larger angle with respect to the touch surface.

In the example shown in (c) of FIG. 15, by being controlled by the angle adjustment section 16, the movable section 14 moves the conductive section 13 so that the angle of inclination of the conductive section 13 with respect to the direction perpendicular to the touch surface becomes 0 degree. This makes it possible to completely curb the influence of the conductive section 13 on the distribution, thus making it possible to eliminate the bias in the distribution. As a result, the distribution is held symmetrical, so variations in touch positions to be detected can be completely eliminated.

As described in Embodiments 1 and 2, variations in touch positions to be detected can be reduced as long as the angle of inclination of the conductive section 13 with respect to the touch surface is a predetermined angle (60 degrees to 90 degrees) at which the difference between the position of contact of the pen tip 12 and the center of gravity of the distribution becomes constant regardless of place on the touch surface (position of contact of the pen tip 12). In other words, a bias (asymmetry) in the distribution in a case where the angle of inclination of the conductive section 13 falls within this range is sufficiently tolerable, as it does not influence variations in touch positions. Accordingly, upon receiving a notification from the touch panel 2b to the effect that a measured distribution is biased at or above a certain level, the angle adjustment section 16 needs only control the movable section 14 to adjust the angle of inclination of the conductive section 13 with respect to the touch surface so that the angle of inclination of the conductive section 13 becomes closer to an angle falling within the range of 60 degrees to 90 degrees.

In order to achieve this, it is only necessary to acquire in advance data indicating a relative relationship between the angle of inclination of the conductive section 13 with respect to the touch surface and the degree of bias in the distribution to be measured at that time, and to prepare the data in the stylus pen 1b. In adjusting the angle of inclination of the conductive section 13 with respect to the touch surface to be a desired angle, the angle adjustment section 16 needs only repetitively adjust the angle of inclination of the conductive section 13 until the angle adjustment section 16 receives, from the touch panel 2b, bias data corresponding to the desired angle.

As stated above, as with the stylus pen 1 of Embodiment 1, the stylus pen 1b according to the present embodiment makes it possible to reduce a bias in a distribution of the sizes of changes in capacitance as generated by the pen tip 12. This makes it possible to, even when the pen tip 12 is sufficiently small, reduce variations in touch detection positions when the stylus pen lb is tilted.

### Conclusion

An information input pen (stylus pen 1) according to Aspect 1 of the present invention is an information input pen for inputting information to a capacitive touch panel, including:

a non-conductive pen body;

a conductive pen tip; and

a conductive section electrically connected to the pen tip and obliquely disposed with respect to a length direction of the pen body,

wherein when the pen tip comes into contact with or proximity to a touch surface of the touch panel, an angle of inclination of a length direction of the conductive section with respect to the touch surface of the touch panel is a predetermined angle at which a difference between a position of contact or proximity of the pen tip on or to the touch surface and a center of gravity of a distribution of sizes of changes in capacitance as generated by the pen tip coming into contact with or proximity to the touch surface becomes constant regardless of place on the touch surface.

According to the configuration, when the pen tip comes into contact with or proximity to the touch surface of the touch panel, the difference between an actual position of contact or proximity of the pen tip on or to the touch surface and the center of gravity of a measured distribution of the sizes of changes in capacitance becomes constant regardless of place on the touch surface. This makes it possible to reduce the influence of the conductive section on the distribution of the sizes of the changes in capacitance, thus making it possible to reduce variations in positions of contact or proximity to be detected.

Further, the angle of inclination of the conductive section with respect to the direction perpendicular to the touch surface remains small even when the angle of inclination of the information input pen with respect to the direction perpendicular to the touch surface is made larger. Therefore, even in a case where the stylus pen is greatly tilted with respect to the direction perpendicular to the touch surface, variations in positions of contact or proximity to be detected can be reduced.

Furthermore, since the influence of the conductive section on the distribution to be measured of the sizes of changes in capacitance is small, it is not necessary to make the pen tip larger to reduce the influence. Therefore, even when the pen tip is sufficiently small, variations in positions of contact or proximity to be detected when the stylus pen is greatly tilted can be reduced.

An information input pen (stylus pen 1a) according to Aspect 2 of the present invention is an information input pen for inputting information to a capacitive touch panel that detects contact or proximity of the information input pen, including:

a non-conductive pen body;

a conductive pen tip;

a conductive section electrically connected to the pen tip;

a movable section that, when contact or proximity of the information input pen is not detected by the touch panel, moves the conductive section so that an angle of inclination of a length direction of the conductive section with respect to the touch surface of the touch panel becomes a predetermined angle at which a difference between a position of contact or proximity of the pen tip on or to the touch surface and a center of gravity of a distribution of sizes of changes in capacitance as generated by the pen tip coming into contact with or proximity to the touch surface becomes constant regardless of place on the touch surface; and

a fixing section that fixes the conductive section when proximity of the information input pen has been detected by the touch panel.

According to the configuration, after the information input pen has been detected by the touch panel, the difference between an actual position of contact or proximity of the pen tip on or to the touch surface and the center of gravity of a measured distribution of the sizes of changes in capacitance becomes constant regardless of place on the touch surface. This makes it possible to reduce the influence of the conductive section on the distribution of the sizes of the changes in capacitance, thus making it possible to reduce variations in positions of contact or proximity to be detected.

Further, the angle of inclination of the conductive section with respect to the direction perpendicular to the touch surface remains small even when the angle of inclination of the information input pen with respect to the direction perpendicular to the touch surface is made larger. Therefore, even in a case where the stylus pen is greatly tilted with respect to the direction perpendicular to the touch surface, variations in positions of contact or proximity to be detected can be reduced.

Furthermore, since the influence of the conductive section on the distribution to be measured of the sizes of changes in capacitance is small, it is not necessary to make the pen tip larger to reduce the influence. Therefore, even when the pen tip is sufficiently small, variations in positions of contact or proximity to be detected when the stylus pen is greatly tilted can be reduced.

An information input pen (stylus pen 1b) according to Aspect 3 of the present invention is an information input pen for inputting information to a capacitive touch panel that measures a distribution of sizes of changes in capacitance as generated by a pen tip of the information input pen coming into contact with or proximity to a touch surface, including:

a non-conductive pen body;

the pen tip, which is conductive;

a conductive section electrically connected to the pen tip; and

a movable section that, upon being notified by the touch panel that the distribution thus measured is biased at or above a certain level, moves the conductive section so that an angle of inclination of a length direction of the conductive section with respect to the touch surface of the touch panel becomes closer to a predetermined angle at which a difference between a position of contact or proximity of the pen tip on or to the touch surface and a center of gravity of a distribution of sizes of changes in capacitance as generated by the pen tip coming into contact with or proximity to the touch surface becomes constant regardless of place on the touch surface.

According to the configuration, in a case where there is a bias in a measured distribution of the sizes of changes in capacitance, the angle of the conductive section is adjusted so that the difference between an actual position of contact or proximity of the pen tip on or to the touch surface and the center of gravity of a measured distribution of the sizes of changes in capacitance becomes constant regardless of place on the touch surface. Once this adjustment is completed, the influence of the conductive section on the distribution of the sizes of the changes in capacitance can be reduced, so variations in positions of contact or proximity to be detected can be reduced.

Further, after the completion of the adjustment, the angle of inclination of the conductive section with respect to the direction perpendicular to the touch surface remains small even when the angle of inclination of the information input pen with respect to the direction perpendicular to the touch surface is made larger. Therefore, even in a case where the stylus pen is greatly tilted with respect to the direction perpendicular to the touch surface, variations in positions of contact or proximity to be detected can be reduced.

Furthermore, since, after the completion of the adjustment, the influence of the conductive section on the distribution to be measured of the sizes of changes in capacitance is small, it is not necessary to make the pen tip larger to reduce the influence. Therefore, even when the pen tip is sufficiently small, variations in positions of contact or proximity to be detected when the stylus pen is greatly tilted can be reduced.

In Aspects 1 to 3, an information input pen according to Aspect 4 of the present invention is configured such that the predetermined angle is 60 degrees or lager and 90 degrees or smaller.

The configuration makes it possible to, regardless of mesh spacing of the touch panel, variations in positions of contact or proximity to be detected.

An information input system (touch input system 100) according to Aspect 5 of the present invention includes: an information input pen according to any of Aspects 1 to 4; and a capacitive touch panel.

The configuration makes it possible to provide an information input system that makes it possible to, even when a pen tip of a stylus pen is sufficiently small, reduce variations in positions of contact or proximity to be detected when a pen body is tilted.

The present invention is not limited to the description of the embodiments above, but may be altered within the scope of the claims. An embodiment based on a proper combination of technical means disclosed in different embodiments is encompassed in the technical scope of the present invention. Furthermore, a new technical feature may be formed by combining technical means disclosed in each separate embodiment.

### Industrial Applicability

The present invention is applicable to an information input pen for inputting information to a capacitive touch panel and an information input system including such an information input pen and a capacitive touch panel.

### Reference Signs List

1, 1a, 1b Stylus pen (information input pen)

2, 2a, 2b Touch panel

10 Pen body

11 Depression

12 Pen tip

13 Conductive section

14 Movable section

15 Fixing section

40 Proximity detection section

41 Fixing instruction section

42 Distribution bias determination section

43 Angle adjustment instruction section

100, 100a, 100b Touch input system (information input system)

1. An information input pen for inputting information to a capacitive touch panel, comprising:
a non-conductive pen body;
a conductive pen tip; and
a conductive section electrically connected to the pen tip and obliquely disposed with respect to a length direction of the pen body,
wherein when the pen tip comes into contact with or proximity to a touch surface of the touch panel, an angle of inclination of a length direction of the conductive section with respect to the touch surface of the touch panel is a predetermined angle at which a difference between a position of contact or proximity of the pen tip on or to the touch surface and a center of gravity of a distribution of sizes of changes in capacitance as generated by the pen tip coming into contact with or proximity to the touch surface becomes constant regardless of place on the touch surface.

2. An information input pen for inputting information to a capacitive touch panel that detects contact or proximity of the information input pen, comprising:
a non-conductive pen body;
a conductive pen tip;
a conductive section electrically connected to the pen tip;
a movable section that, when contact or proximity of the information input pen is not detected by the touch panel, moves the conductive section so that an angle of inclination of a length direction of the conductive section with respect to the touch surface of the touch panel becomes a predetermined angle at which a difference between a position of contact or proximity of the pen tip on or to the touch surface and a center of gravity of a distribution of sizes of changes in capacitance as generated by the pen tip coming into contact with or proximity to the touch surface becomes constant regardless of place on the touch surface; and
a fixing section that fixes the conductive section when proximity of the information input pen has been detected by the touch panel.

3. An information input pen for inputting information to a capacitive touch panel that measures a distribution of sizes of changes in capacitance as generated by a pen tip of the information input pen coming into contact with or proximity to a touch surface, comprising:
a non-conductive pen body;
the pen tip, which is conductive;
a conductive section electrically connected to the pen tip; and
a movable section that, upon being notified by the touch panel that the distribution thus measured is biased at or above a certain level, moves the conductive section so that an angle of inclination of a length direction of the conductive section with respect to the touch surface of the touch panel becomes closer to a predetermined angle at which a difference between a position of contact or proximity of the pen tip on or to the touch surface and a center of gravity of a distribution of sizes of changes in capacitance as generated by the pen tip coming into contact with or proximity to the touch surface becomes constant regardless of place on the touch surface.

4. The information input pen according to claim 1, wherein the predetermined angle is 60 degrees or lager and 90 degrees or smaller.

5. An information input system comprising:
an information input pen according to claim 1; and
a capacitive touch panel.

6. The information input pen according to claim 2, wherein the predetermined angle is 60 degrees or lager and 90 degrees or smaller.

7. An information input system comprising:
an information input pen according to claim 2; and
a capacitive touch panel.

8. The information input pen according to claim 3, wherein the predetermined angle is 60 degrees or lager and 90 degrees or smaller.

9. An information input system comprising:
an information input pen according to claim 3; and a capacitive touch panel.
